(19) United States
(12) Patent Application Publication
(10) Pub. No.: US 2007/0083788 A1
(43) Pub. Date: Apr. 12, 2007

(54) Method and apparatus for testing for open ports of an endpoint device in a packet network

(75) Inventors: Gerald R. Johnson, Cataumet, MA (US); Thomas F. Kister, Chalfont, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(73) Assignee: General Instrument Corporation

(21) Appl. No.: 11/244,818

(22) Filed: Oct. 6, 2005

(51) Int. Cl. G06F 11/00

(52) U.S. Cl. 714/1

(57) ABSTRACT

Method, apparatus, and computer readable medium for testing for an open port of an endpoint device in a communication network is described. A test request message is sent from the endpoint device to a server. The test request message is configured to request the server to send a test message to a port of the endpoint device using a protocol. The port is polled for the test message during a time period. The port is indicated as being open if the test message is received by the endpoint device at the port before expiration of the time period. A connect failure message is sent to the server if the test message is not received by the endpoint device at the port before expiration of the time period. The connect failure message may be configured to request the server to send another test message to the endpoint device.

### BACKGROUND OF THE INVENTION

1. Field of the Invention

The present invention relates to packet networks and, more particularly, to a method and apparatus for testing for open ports of an endpoint device in a packet network.

2. Description of the Background Art

Some software applications running on endpoint devices in a packet network require arbitrary hosts in the network to initiate connections. For example, a software application running on a computer in a home may require a host on the Internet to initiate a connection. In a home or small office environment, for example, the software application resides in a device (e.g., computer) connected to the Internet through a local gateway and an internet service provider (ISP). In other environments (e.g., enterprise environments), more elaborate Internet connections are employed using various servers, routers, switches, and the like.

In a packet network, a “port” is an endpoint to a logical connection between devices (e.g., an endpoint device and a host). A port is typically identified by a number. For example, in a transmission control protocol/internet protocol (TCP/IP) network, some ports have numbers that are pre-assigned by the Internet Assigned Numbers Authority (IANA) and are referred to as the “well-known ports.”

In general, some ports of an endpoint device may be blocked by the device or system connecting the endpoint device to the Internet and/or by an ISP. For example, a locate gateway in a home (e.g., a home router) may be configured to block certain ports to prevent unauthorized access to endpoint devices (e.g., port 21 for file transfer protocol (FTP)). If the default port used by a software application is blocked, the software application cannot communicate with its intended host. While the software application may be configured to use alternative ports, a user may not know which ports are open and which are blocked in order to change the configuration of the software application. Accordingly, there exists a need in the art for a method and apparatus for testing for open ports of an endpoint device in a communication network.

### SUMMARY OF THE INVENTION

Method, apparatus, and computer readable medium for testing for an open port of an endpoint device in a communication network. A test request message is sent from the endpoint device to a server. The test request message is configured to request the server to send a test message to a port of the endpoint device using a protocol. The port is polled for the test message during a time period. The port is indicated as being open if the test message is received by the endpoint device at the port before expiration of the time period. A connect failure message is sent to the server if the test message is not received by the endpoint device at the port before expiration of the time period. The connect failure message may be configured to request the server to send another test message to the endpoint device using the same port and the same or different protocol, or to a different port, using the same or different protocol. The test request message is sent to the server using a predefined port and a predefined protocol. In one embodiment, the test message is sent to the server using port 80 and hypertext transfer protocol (HTTP).

### BRIEF DESCRIPTION OF DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram depicting an exemplary embodiment of a communication network;

FIG. 2 is a flow diagram depicting an exemplary embodiment of a method for testing for an open port of an endpoint device in a communication network in accordance with one or more aspects of the invention;

FIG. 3 is a flow diagram depicting an exemplary embodiment of a method for processing a connection test request at a server in accordance with one or more aspects of the invention; and

FIG. 4 is a block diagram depicting an exemplary embodiment of a computer suitable for implementing the processes and methods described herein.

To facilitate understanding, identical reference numerals have been used, where possible, to designate identical elements that are common to the figures.

### DETAILED DESCRIPTION OF THE INVENTION

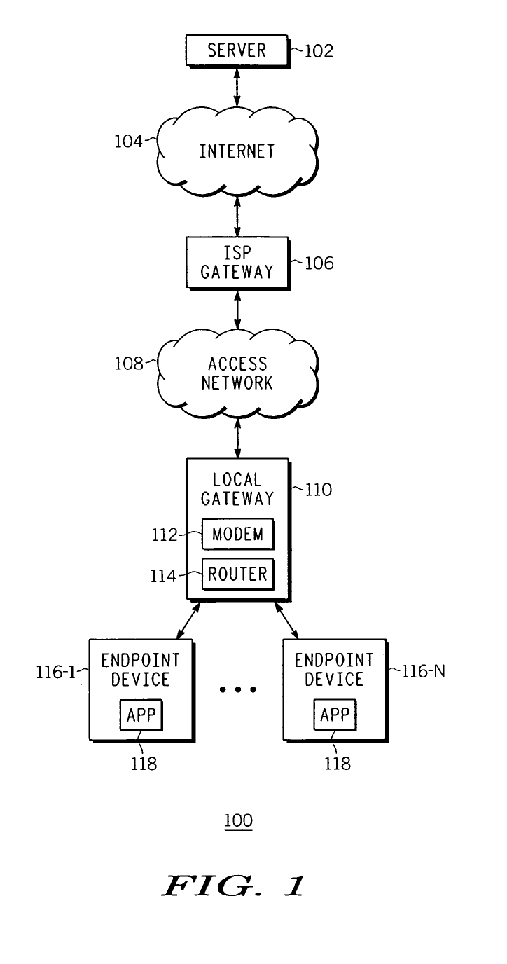

FIG. 1 is a block diagram depicting an exemplary embodiment of a packet network 100. The packet network 100 includes a server 102, a network 104 (e.g., the Internet), an internet service provider (ISP) gateway 106, an access network 108, a local gateway 110, and endpoint devices 116-1 through 116-N (collectively referred to as endpoint devices 116), where N is an integer greater than zero. In general, the endpoint devices 116 communicate with hosts coupled to the Internet 104, such as the server 102, via the local gateway 110, the access network 108, and the ISP gateway 106.

In particular, each of the endpoint devices 116 is in communication with the local gateway 110. For example, the endpoint devices 116 may comprise computers. The local gateway 110 provides an interface between the endpoint devices 116 and the access network 108. The local gateway 110 may include a modulator/demodulator (modem) 112 and a router 114. Notably, the local gateway 110 is configured to block certain ports of the endpoint devices 116 for security reasons. The modem 112 is configured to send signals to, and receive signals from, the access network 108 in accordance with the particular protocol of the access network 108. The access network 108 may comprise any type of access facility known in the art, such as a cable facility, a digital subscriber line (DSL) facility, and the like. Accordingly, the modem 112 may be a cable modem, DSL modem, and the like corresponding to the type of access network 108.

The router 114 is configured to route packets between the access network 108 and the endpoint devices 116. The router 114 may also facilitate a local area network (LAN) among the endpoint devices 116. For purposes of clarity by example, the local gateway 110 is shown as having a modem and a router. Those skilled in the art will appreciate that the local gateway 110 may include other types of components in place of or in addition to the router 114, such as hubs, switches, bridges, servers, and the like. In addition, although the modem 112 and the router 114 are shown as part of a single device, it is to be understood that the modem 112 and the router 114 may be separate devices.

The local gateway 110 is configured to communicate with the ISP gateway 106 via the access network 108. The ISP gateway 106 provides an interface between the local gateway 110 and the Internet 104. The ISP gateway 106 may comprise various servers, such as a gateway server, a domain name server (DNS), and the like to facilitate communication between the local gateway 110 and the Internet 104.

Each of the endpoint devices 116 is configured to test for open ports in accordance with one or more aspects of the invention. In one embodiment, each of the endpoint devices 116 executes program code 118 configured to test for open ports. As discussed above, “port” is an endpoint to a logical connection between devices (e.g., an endpoint device 116 and the server 102). In operation, the program code 118 sends a test request message towards the server 102 using a pre-defined port and pre-defined protocol. The pre-defined port and protocol is selected such that the test request message will not be blocked by the local gateway 110 or the ISP 106. In one embodiment, the pre-defined port is the well-known port 80 and the test request message is sent using the hypertext transfer protocol (HTTP). Since port 80 is used by software on the endpoint devices 116 for browsing the worldwide web (WWW), port 80 is typically not blocked by the local gateway 110 and the ISP 106. The test request message may be embedded within an HTTP command. As such, to the local gateway 110 and the ISP gateway 106, it looks like the program code 118 is browsing the web.

The test request message is configured to request the server 102 to send a test message to a selected port using a selected protocol. The selected port may be any of the possible ports (e.g., in TCP/IP, ports range from 0 through 65536). The selected protocol may be any of the various protocols known in the art, such as TCP or user datagram protocol (UDP).

The server 102 first acknowledges the test request message on the pre-defined port using the pre-defined protocol (e.g., port 80 using HTTP) to let the program code 118 know that the test request message was received and the test is about to occur. The server 102 then attempts to send a test message to the program code 118 using the selected port and the selected protocol dictated by the test request message. If the program code 118 receives the test message, the program code 118 acknowledges receipt to the server 102 and indicates that the test is successful (i.e., the selected protocol may be used to communicate via the selected port). If the program code 118 does not receive the test message from the server 102 before expiration of a time period (i.e., a timeout period), the program code 118 sends a connect failure message to the server 102 indicating that the test message was not received using the selected port and the selected protocol. The program code 118 may optionally indicate in the connect failure message to the server 102 to try again on the same port using the same or different protocol, or try again using a different port with the same or different protocol. The server 102 acknowledges the message and proceeds with the test. The process is then repeated.

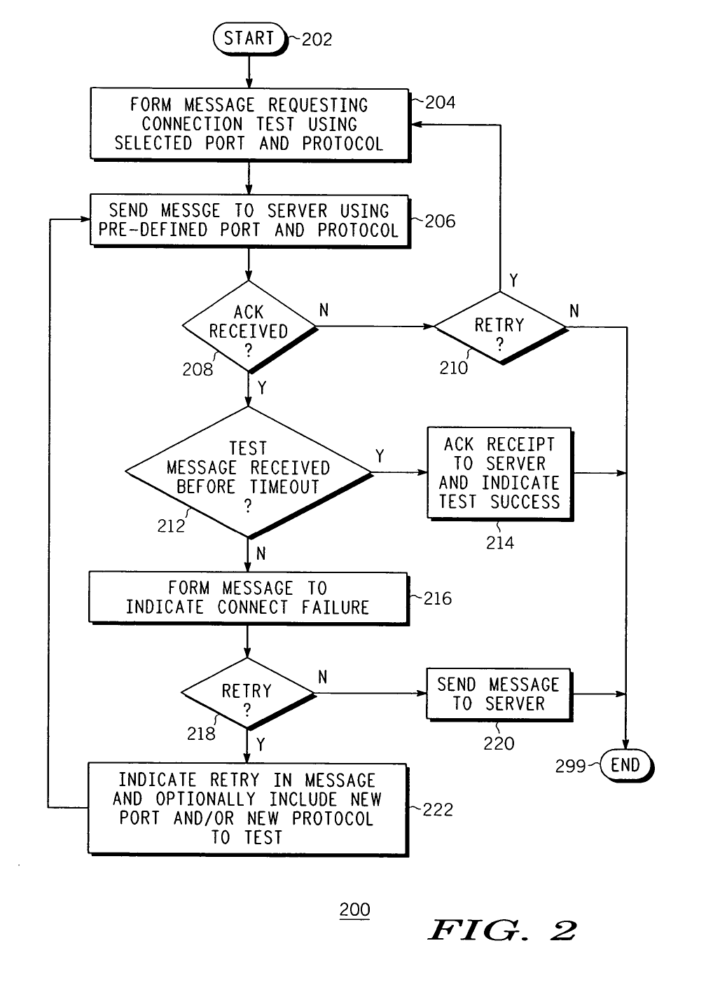

FIG. 2 is a flow diagram depicting an exemplary embodiment of a method 200 for testing for an open port of an endpoint device in a packet network in accordance with one or more aspects of the invention. The method 200 begins at step 202. At step 204, a message is formed requesting a connection test using a selected port and a selected protocol. At step 206, the message is sent to a server using a pre-defined port and a pre-defined protocol. The pre-defined port and the pre-defined protocol are selected such that the message is not blocked by any intervening device, such as a local gateway and/or ISP. In one embodiment, the pre-defined port and protocol is port 80 using HTTP. At step 208, a determination is made whether an acknowledgement of the message from the server has been received during a timeout period. If not, the method 200 proceeds to step 210, where a determination is made whether to retry the connection test. If not, the method 200 ends at step 299. Otherwise, the method 200 returns to step 204 and repeats.

If, at step 208, an acknowledgement is received from the server during the timeout period, the method 200 proceeds to step 212. At step 212, a determination is made whether a test message is received from the server during the timeout period. That is, the endpoint device polls the selected port for the test message during the timeout period. If a test message is received, the method 200 proceeds to step 214. At step 214, an acknowledgment of receipt of the test message is sent to the server and success of the test is indicated. The selected port may be indicated as being open. The method 200 then ends at step 299.

If, at step 212, the test message is not received from the server during the timeout period, the method 200 proceeds to step 216. At step 216, a message is formed to indicate connect failure. At step 218, a determination is made whether to retry the connection test. If not, the method 200 proceeds to step 220, where the message is sent to the server. The method 200 then ends at step 299.

If, at step 218, the test connection is to be retried, the method 200 proceeds to step 222. At step 222, the message is augmented to indicate that the server is to retry the connection test. Optionally, the message is augmented to include a new port and/or a new protocol to test. The method 200 then returns to step 206 and repeats.

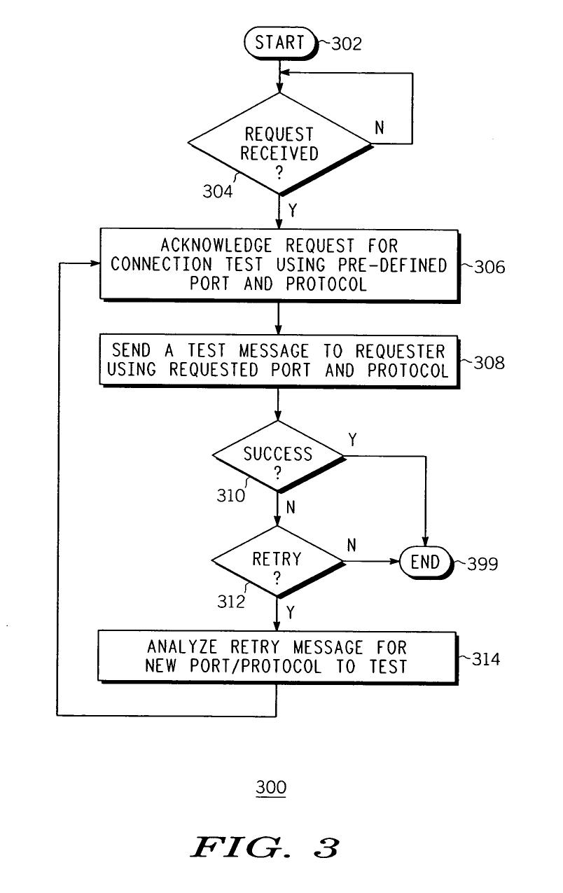

FIG. 3 is a flow diagram depicting an exemplary embodiment of a method 300 for processing a connection test request at a server in accordance with one or more aspects of the invention. The method 300 begins at step 302. At step 304, a determination is made whether a connection test request has been received from a requestor (e.g., endpoint device). If not, step 302 is repeated. Otherwise, the method 300 proceeds to step 306. At step 306, an acknowledgement for the request is sent to the requester using a pre-defined port and protocol (e.g., port 80 using HTTP). At step 308, a test message is sent to the requestor using the requested port and protocol for the connection test. At step 310, a determination is made whether the connection test is a success. For example, the server may receive an acknowledgement of the test message from the requestor. If the test is a success, the method 300 ends at step 399.

Alternatively, the server may receive a message from the requestor indicating connection failure. If the test is not successful, the method 300 proceeds to step 312. At step 312, a determination is made whether to retry the test. If not, the method 300 ends at step 399. Otherwise, the method 300 proceeds to step 314. For example, the connect failure message received from the requestor may include instructions for retrying the test. The test may be performed using the same port and protocol as the original failed test, or the connect failure message may include instructions to use a new port and/or new protocol in the test. That is, at step 314, the retry message is analyzed to determine if a new port and/or new protocol is to be used. The method 300 then returns to step 306 and repeats.

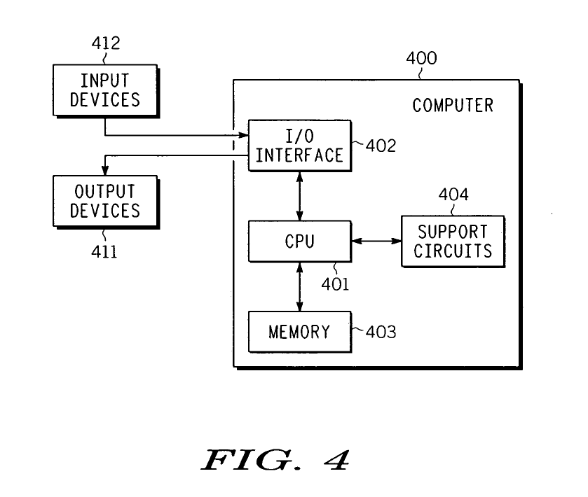

FIG. 4 is a block diagram depicting an exemplary embodiment of a computer 400 suitable for implementing the processes and methods described herein. The computer 400 may be used to implement one or more of the endpoint devices 116, as well as the server 102. The computer 400 includes a processor 401, a memory 403, various support circuits 404, and an I/O interface 402. The processor 401 may be any type of microprocessor known in the art. The support circuits 404 for the processor 401 include conventional cache, power supplies, clock circuits, data registers, I/O interfaces, and the like. The I/O interface 402 may be directly coupled to the memory 403 or coupled through the processor 401. The I/O interface 402 may be coupled to various input devices 412 and output devices 411, such as a conventional keyboard, mouse, printer, display, and the like.

The memory 403 may store all or portions of one or more programs, program information, and/or data to implement the processes and methods described herein. For example, the memory 403 may store the software application 118 for executing the method 200 of FIG. 2. Alternatively, if the memory 403 may store software for performing the method 300 of FIG. 3. Although one or more aspects of the invention are disclosed as being implemented as a computer executing a software program, those skilled in the art will appreciate that the invention may be implemented in hardware, software, or a combination of hardware and software. Such implementations may include a number of processors independently executing various programs and dedicated hardware, such as ASICs.

The computer 400 may be programmed with an operating system, which may be OS/2, Java Virtual Machine, Linux, Solaris, Unix, Windows, Windows95, Windows98, Windows NT, and Windows2000, WindowsME, and WindowsXP, among other known platforms. At least a portion of an operating system may be disposed in the memory 403. The memory 403 may include one or more of the following random access memory, read only memory, magneto-resistive read/write memory, optical read/write memory, cache memory, magnetic read/write memory, and the like, as well as signal-bearing media as described below.

An aspect of the invention is implemented as a program product for use with a computer system. Program(s) of the program product defines functions of embodiments and can be contained on a variety of signal-bearing media, which include, but are not limited to: (i) information permanently stored on non-writable storage media (e.g., read-only memory devices within a computer such as CD-ROM or DVD-ROM disks readable by a CD-ROM drive or a DVD drive); (ii) alterable information stored on writable storage media (e.g., floppy disks within a diskette drive or hard-disk drive or read/writable CD or read/writable DVD); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct functions of the invention, represent embodiments of the invention.

While the foregoing is directed to illustrative embodiments of the present invention, other and further embodiments of the invention may be devised without departing from the basic scope thereof, and the scope thereof is determined by the claims that follow.

What is claimed is:

1. A method of testing for an open port of an endpoint device in a communication network, comprising:
sending a test request message from the endpoint device to a server, the test request message configured to request the server to send a test message to a port of the endpoint device using a protocol; and
polling the port for the test message during a time period; and
indicating that the port is open if the test message is received by the endpoint device at the port before expiration of the time period.

2. The method of claim 1, wherein the test request message is sent to the server using a predefined port and a predefined protocol.

3. The method of claim 2, wherein the predefined port is port 80 and wherein the predefined protocol is the hypertext transfer protocol (HTTP).

4. The method of claim 1, further comprising:
sending a connect failure message to the server if the test message is not received by the endpoint device at the port before expiration of the time period.

5. The method of claim 4, wherein the connect failure message is configured to request the server to send another test message to the endpoint device.

6. The method of claim 5, wherein the connect failure message is configured to request the server to send the other test message to the port using the protocol or another protocol.

7. The method of claim 5, wherein the connect failure message is configured to request the server to send the other test message to another port using the protocol or another protocol.

8. The method of claim 1, further comprising:
receiving an acknowledgement from the server in response to the test request message;
wherein the step of polling is performed in response to the acknowledgement.

9. Apparatus for testing for an open port of an endpoint device in a communication network, comprising:
means for sending a test request message from the endpoint device to a server, the test request message configured to request the server to send a test message to a port of the endpoint device using a protocol; and
means for polling the port for the test message during a time period; and
means for indicating that the port is open if the test message is received by the endpoint device at the port before expiration of the time period.

10. The apparatus of claim 9, wherein the test request message is sent to the server using a predefined port and a predefined protocol.

11. The apparatus of claim 10, wherein the predefined port is port 80 and wherein the predefined protocol is the hypertext transfer protocol (HTTP).

12. The apparatus of claim 9, further comprising:
means for sending a connect failure message to the server if the test message is not received by the endpoint device at the port before expiration of the time period.

13. The apparatus of claim 12, wherein the connect failure message is configured to request the server to send another test message to the endpoint device.

14. The apparatus of claim 13, wherein the connect failure message is configured to request the server to send the other test message to the port using the protocol or another protocol.

15. The apparatus of claim 13, wherein the connect failure message is configured to request the server to send the other test message to another port using the protocol or another protocol.

16. A computer readable medium having stored thereon instructions that, when executed by a processor, cause the processor to perform a method of testing for an open port of an endpoint device in a communication network, comprising:
sending a test request message from the endpoint device to a server, the test request message configured to request the server to send a test message to a port of the endpoint device using a protocol; and
polling the port for the test message during a time period; and
indicating that the port is open if the test message is received by the endpoint device at the port before expiration of the time period.

17. The computer readable medium of claim 16, wherein the test request message is sent to the server using a predefined port and a predefined protocol.

18. The computer readable medium of claim 17, wherein the predefined port is port 80 and wherein the predefined protocol is the hypertext transfer protocol (HTTP).

19. The computer readable medium of claim 16, further comprising:
sending a connect failure message to the server if the test message is not received by the endpoint device at the port before expiration of the time period.

20. The computer readable medium of claim 19, wherein the connect failure message is configured to request the server to send another test message to the endpoint device.
